(19) United States
(12) Patent Application Publication
(10) Pub. No.: US 2017/0083906 A1
(43) Pub. Date: Mar. 23, 2017

(54) TOKEN ASSURANCE LEVEL BASED TRANSACTION PROCESSING

(71) Applicant: International Business Machines Corporation, Armonk, NY (US)

(72) Inventors: Nitin Gaur, Round Rock, TX (US); William J. O'Donnell, Fichburg, WI (US)

(21) Appl. No.: 14/859,401

(22) Filed: Sep. 21, 2015

(51) Int. Cl. G06Q 20/36; G06Q 20/38

(52) U.S. Cl. CPC G06Q 20/367; G06Q 20/3829

(57) ABSTRACT

Embodiments relate to token assurance level based transaction processing. An aspect includes receiving, from a requester by a tokenization server in an electronic payment system, a request for de-tokenization of a token corresponding to a transaction. Another aspect includes determining a token assurance level of the token. Another aspect includes based on the token assurance level of the token; assigning a quality of service to the transaction. Yet another aspect includes performing the de-tokenization based on the assigned quality of service and returning an account number corresponding to the token to the requester.

### BACKGROUND

The present invention relates generally to payment tokenization in electronic transaction systems, and more specifically, to token assurance level based transaction processing.

Use of bank cards, credit cards, debit cards or cash cards for making payments is becoming more and more frequent. These payment systems are relatively secure because they employ extensive security mechanisms. Usually a secret code must be provided by a purchaser and authenticated by a bank, to authorize the movement of funds from the purchaser's account to the vendor. Recent years have seen rapid growth in the use of credit cards and/or debit cards to purchase merchandise at point-of-sale locations, through public telephones or over the Internet. During these purchase transactions, some personal data is publicly released, albeit in a very limited way.

However, in view of the inherently public nature of telephone networks and/or the Internet, this personal information is at risk of interception. Identity theft is recognized as an increasingly important crime, wherein, despite all of the security checks used to authenticate and protect personal information, a credit/debit card may be cloned and used by malicious persons to rob money from the bank account of a legitimate user. In fact, in view of the almost instantaneous nature of today electronic transactions, even temporary ownership of a credit (or other payment) card could allow a malicious user to make a large number of payments either particularly through Internet.

### SUMMARY

Embodiments include a method, system, and computer program product for token assurance level based transaction processing. An aspect includes receiving, from a requester by a tokenization server in an electronic payment system, a request for de-tokenization of a token corresponding to a transaction. Another aspect includes determining a token assurance level of the token. Another aspect includes based on the token assurance level of the token; assigning a quality of service to the transaction. Yet another aspect includes performing the de-tokenization based on the assigned quality of service and returning an account number corresponding to the token to the requester.

### BRIEF DESCRIPTION OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a payment tokenization system for token assurance level based transaction processing in accordance with an embodiment;

FIG. 2 depicts a system for token assurance level based transaction processing in accordance with an embodiment; and

FIG. 3 depicts a process flow for token assurance level based transaction processing in accordance with an embodiment; and

FIG. 4 depicts an embodiment of a computer system for use in conjunction with embodiments of token assurance level based transaction processing.

### DETAILED DESCRIPTION

Embodiments of token assurance level based transaction processing are provided, with exemplary embodiments being discussed below in detail. Payment tokenization is used in payment technology and mobile payments systems, including near field communication (NFC), host card emulation (HCE), cloud based security (SE) and mobile wallets/mobile point of sale (mPOS) systems. Payment tokenization attempts to ensure personal account number (PAN) privacy for use cases including card present and card-not-present transactions, and aims to reduce fraud by masking real credit account numbers using tokens. However, not all tokens are created or treated equally. Some tokens, while not real credit account numbers, may be stolen and temporarily used, leading to fraud and loss. Payment tokenization is implemented using data substitution, i.e. substituting an anonymous token for a personal account number. The idea behind the token is to protect sensitive data, and to ensure that if the token is lost or stolen the data is preserved or uncompromised. A token may also include metadata, and various additional information may be included in token metadata, such as time of expiration or access policies.

A token assurance level (TAL) may be assigned to a token to allow the token service provider to indicate the confidence level of the binding between the payment token and the PAN/cardholder. The token assurance level may be determined based on the type of identification and verification of the user that was performed by the merchant for the transaction, and based on the identity of the entity that performed the identification and verification. The token assurance level may be used to determine a processing priority of a transaction in a payment tokenization system. Token assurance level based transaction processing may include tagging of payment tokens with a token assurance level based on (for example): the identity of token service providers and/or token requestors; the security exposure of the token (i.e., based on, for example, merchant type, device finger printing, or personal identification number (PIN) requirement). A processing quality of service (QoS) is assigned to the transaction based on the token assurance level, and may include prioritized queuing for token processing and validation (for example, a higher token assurance level would not be subjected to any additional verification that might be required for a lower token assurance level).

In some embodiments, there may be four token assurance levels. A level 1 token assurance level indicates little or no confidence in the asserted identity's validity. Level 2 indicates some confidence in the asserted identity's validity. Level 3 indicates high confidence in the asserted identity's validity, and level 4 indicates very high confidence in the asserted identity's validity. Each token assurance level may have a different assigned quality of service for processing. Further, different levels and/or types of additional verification may be required from the user and/or the merchant for different token assurance levels.

A payment tokenization system may include various components. A token service provider (TSP) is issues tokens corresponding to personal account numbers that are issued to users by an issuer, such as Visa™ or Mastercard™. A token vault provider (TVP) is usually the same entity as the TSP, and is an entity that keeps the tokens safe and has the original mapping of tokens to personal account numbers. A transaction processor gateway (TPG) is included at both the merchant and issuer, and receives the token for approval and processing. Before processing the transaction by the transaction processor, the token needs to be de-tokenized, i.e., converted back to the account number. Token assurance level based transaction processing is implemented before de-tokenization in a payment tokenization system.

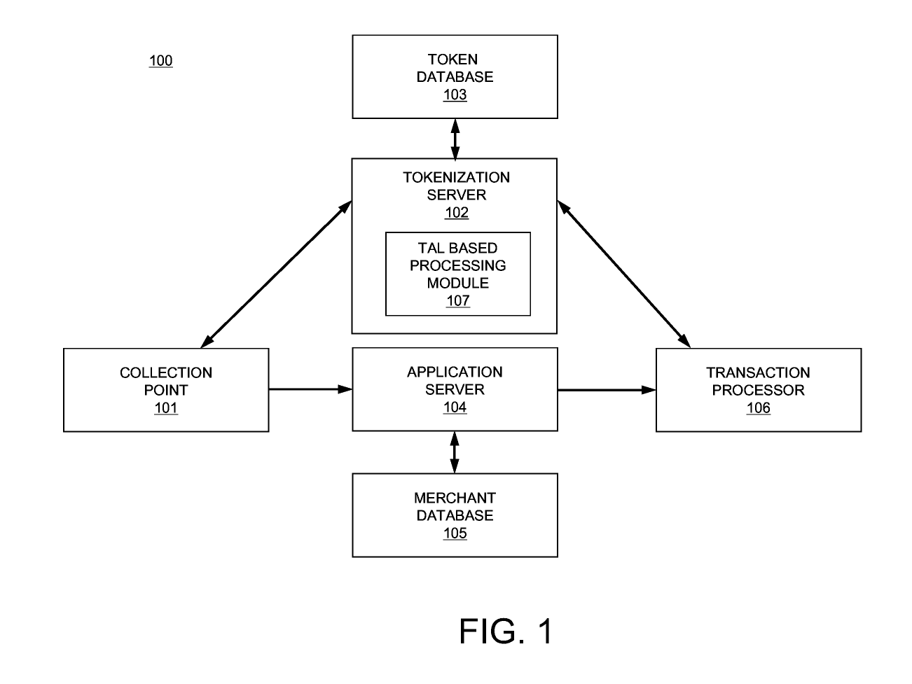

Turning now to FIG. 1, a payment tokenization system 100 for token assurance level based transaction processing generally shown. System 100 includes a collection point 101 which may be, in various embodiments, a point of sale system or an online payment interface belonging to a merchant. When a transaction is initiated at the collection point 101, an account number is collected and encrypted with a public key belonging to the tokenization server 102, and then the encrypted account number is sent from the collection point 101 to the tokenization server 102. The tokenization server 102 generates a random token corresponding to the transaction and stores the generated token in the token database 103 with the account number. A single account number may be mapped to many tokens in the token database 103; however, each token may only be mapped to a single account number. The tokenization database also sends the token to the collection point 101. The collection point 101 sends the token to the merchant's application server 104, which uses the token for processing the transaction instead of the account number. The application server 104 stores the token in an entry corresponding to the transaction in merchant database 105, and also sends the token to the transaction processor 106. The transaction processor 106 sends the token to back to the tokenization server 102, which de-tokenizes the token, i.e., converts the token back to the account number based on the entry in the token database 103 and sends the account number back to the transaction processor 106. The transaction processor may then complete processing of the transaction based on the account number. Therefore, no account numbers are stored in the merchant database 105 during processing of the transaction. However, in some embodiments, the token may be de-tokenized on the merchant side (i.e., in application server 104). Tokenization server 102 includes a transaction assurance level based processing module 107, which implements embodiments of token assurance level based transaction processing. In embodiments of token assurance level based transaction processing, the transaction is assigned a token assurance level. Based on the assigned token assurance level, a transaction may receive expedited processing for de-tokenization, or may require additional information from the merchant and/or the holder of the card before de-tokenization is performed by the tokenization server 102. The tokenization server 102 may perform the de-tokenization based on the assigned token assurance level, e.g., transactions having a relatively high token assurance level may receive expedited processing at tokenization server 102. FIG. 1 is shown for illustrative purposes only; a payment tokenization system may have any appropriate components that communicate in any appropriate manner.

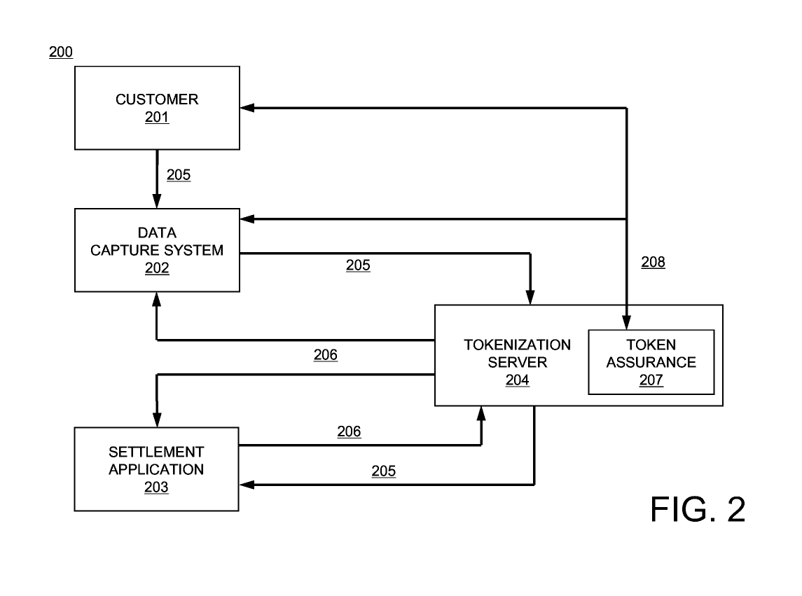

FIG. 2 illustrates an embodiment of a system 200 for token assurance level based transaction processing. In system 200, a customer 201 provides an account number 205 to a data capture system 202, which include a point of sale system or web interface associated with a merchant. The data capture system 202 sends the account number 205 to the tokenization server 204, and the tokenization server 204 sends a token 206 corresponding to the account number to both the data capture system 202 and to the settlement application 203. The tokenization server 204 also stores the token with the account number. The settlement application 203 requests the account number from the tokenization server 204 using the token 206. Before the tokenization server returns the account number 205 to the data capture system 202 and settlement application 203, the token assurance module 207 in the tokenization server 204 may determine a token assurance level for the transaction, and, based on the token assurance level may expedite processing of the transaction, or may request additional information 208 from the customer 201 and/or the data capture system 202. FIG. 2 is shown for illustrative purposes only; a payment tokenization system may have any appropriate components that communicate in any appropriate manner.

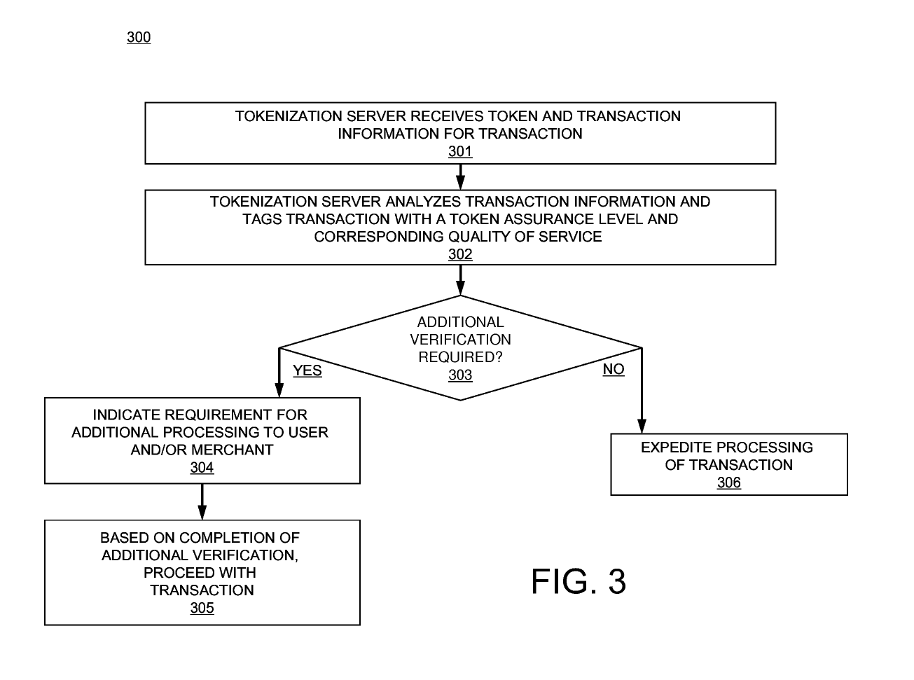

FIG. 3 illustrates an embodiment of a method 300 for token assurance level based transaction processing. Method 300 may be implemented in token assurance level based processing module 107 of FIG. 1, and/or token assurance module 207 of FIG. 2. In block 301, a tokenization server, such as tokenization server 102 of FIG. 1 or tokenization server 204 of FIG. 2, receives a de-tokenization request comprising a token that is associated with a transaction, in addition to metadata comprising additional data associated with the transaction. The additional data may include, but is not limited to, the identity of the token service provides, the identity of the token requestor, the identity or type of the merchant, and whether the collection point included device finger printing, biometric verification of the user, or a pin requirement in the transaction. The additional data may further include a mobile device type and a type of mobile software (for example, ApplePay™ or Square™) used for a mobile purchase. The additional information may further include whether the transaction is a card present or a card not present transaction. In block 302, the tokenization server analyzes the additional information and determines a transaction assurance level for the transaction based on the additional information. In some embodiments, there may be four different token assurance levels. A level 1 token assurance level indicates little or no confidence in the asserted identity's validity. Level 2 indicates some confidence in the asserted identity's validity. Level 3 indicates high confidence in the asserted identity's validity, and level 4 indicates very high confidence in the asserted identity's validity. Each token assurance level may have a different assigned quality of service for processing. Further, different levels of additional verification may be required from the user and/or the merchant for different token assurance levels; for example, for a level 1 transaction, multiple forms of additional verification may be required, while for a level 4 transaction, no additional verification may be required. Further, a level 4 transaction may receive expedited processing.

In block 303, the tokenization server determines a quality of service for the transaction. The quality of service corresponds to a processing speed of the transaction, and includes whether to require additional information based on the token assurance level that was determined in block 302 before proceeding with the transaction (i.e., proceeding with de-tokenization). The determination may be made based on the four levels described above with respect to block 302 in some embodiments. In further embodiments, a dollar amount of the transaction may be taking into account in block 303. For example, either a user or a service provider may specify that additional verification will not be required for any transactions that are below a certain dollar amount, i.e., a verification threshold. In block 303, if additional verification is determined to be required for the transaction, the tokenization server requests the additional verification from the account holder and/or the merchant. It is further determined in block 303 what type of additional verification should be required. The additional verification may vary based on the token assurance level, and may include any appropriate type of verification. Some examples of verification that may be required in block 303 are sending a PIN to a mobile device of the user that must be submitted to the merchant, and then submitted from the merchant to transaction processor; or sending a message to a mobile device of the user that requires a response. If it was determined in block 303 that additional verification is required for the transaction, then, in block 304, it is indicated to the user and/or the merchant that the additional verification is required. Then, in block 305, based on successful completion of the additional verification, the de-tokenization of the transaction proceeds. If it was determined in block 303 that no additional verification is required, the de-tokenization of the transaction receives expedited processing in block 306.

In some embodiments of method 300, the tokenization server may implement a weighted system that determines the TAL of a particular transaction based on metadata associated with the transaction in block 302. For example, the tokenization server may receive the following data for a transaction in block 301:

### [Token Number] [Merchant ID] [Device ID] [Metatag 1] [Metatag 2] . . . [Metatag N]

The metatags 1 to N may include any appropriate information regarding the transaction in various embodiments. The tokenization server may assign scores to the transaction based on the various pieces of metadata that are received with the Token Number. For example, the Merchant ID and Metatag 1 may indicate that the merchant is a known or trusted merchant (for example, a big name retailer), and may rate a score of 20. The Device ID and Metatag 2 may indicate that the payment was made using a device running ApplePay with biometric verification (e.g., a fingerprint), which may rate a score of 50. Metatag N may indicate that the tag was issued by a tier 1 token service provider (for example, Visa), which may rate a score of 10. The tokenization server may then add up the various scores assigned to the various pieces of metadata to determine an overall score for the transaction, and assign a TAL based on the overall score. In this example, the total score would be 80. The total score may be compared to one or more thresholds to determine the TAL in block 302; for example, each level of TAL may have a different respective threshold. The quality of service is then determined based on the TAL. In such a weighted system, a transaction having less associated metadata would generally rate a lower overall score as compared to a transaction that has more associated metadata. However, some pieces of metadata (for example, use of biometric verification) may rate a relatively high overall score even in the absence of other metadata. Further, for a transaction with a relatively large number of metatags that were populated by unknown or high risk entities, the transaction may rate a relatively low overall score. Entities (e.g., merchants) may be added or removed from a trusted list over time, or may have their ratings changed based on their security practices.

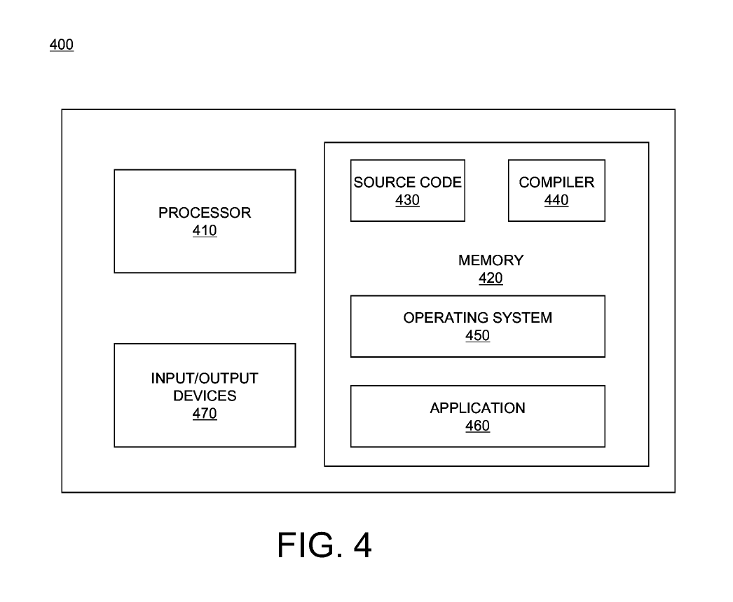

FIG. 4 illustrates an example of a computer 400 which may be utilized by exemplary embodiments of token assurance level based transaction processing. Various operations discussed above may utilize the capabilities of the computer 400. One or more of the capabilities of the computer 400 may be incorporated in any element, module, application, and/or component discussed herein.

The computer 400 includes, but is not limited to, PCs, workstations, laptops, PDAs, palm devices, servers, storages, and the like. Generally, in terms of hardware architecture, the computer 400 may include one or more processors 410, memory 420, and one or more I/O devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a digital signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and one or more applications 460 in accordance with exemplary embodiments. As illustrated, the application 460 comprises numerous functional components for implementing the features and operations of the exemplary embodiments. The application 460 of the computer 400 may represent various applications, computational units, logic, functional units, processes, operations, virtual entities, and/or modules in accordance with exemplary embodiments, but the application 460 is not meant to be a limitation.

The operating system 450 controls the execution of other computer programs, and provides scheduling, input-output control, file and data management, memory management, and communication control and related services. It is contemplated by the inventors that the application 460 for implementing exemplary embodiments may be applicable on all commercially available operating systems.

Application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 470 may include input devices such as, for example but not limited to, a mouse, keyboard, scanner, microphone, camera, etc. Furthermore, the I/O devices 470 may also include output devices, for example but not limited to a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or intranet.

If the computer 400 is a PC, workstation, intelligent device or the like, the software in the memory 420 may further include a basic input output system (BIOS) (omitted for simplicity). The BIOS is a set of essential software routines that initialize and test hardware at startup, start the O/S 450, and support the transfer of data among the hardware devices. The BIOS is stored in some type of read-only-memory, such as ROM, PROM, EPROM, EEPROM or the like, so that the BIOS can be executed when the computer 400 is activated.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 460 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any means that can store the program for use by or in connection with the instruction execution system, apparatus, or device. The computer readable storage medium can be, for example but not limited to, an electronic, magnetic, optical, electromagnetic, or semiconductor system, apparatus, or a device.

More specific examples (a nonexhaustive list) of the computer-readable storage medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable storage medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects and benefits include additional security in a payment tokenization system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for token assurance level based transaction processing, the method comprising:
receiving, from a requester by a tokenization server in an electronic payment system, a request for de-tokenization of a token corresponding to a transaction;
determining a token assurance level of the token;
based on the token assurance level of the token; assigning a quality of service to the transaction; and
performing the de-tokenization based on the assigned quality of service and returning an account number corresponding to the token to the requester.

2. The method of claim 1, wherein the quality of service includes requiring additional verification from a user associated with the account number, and wherein the de-tokenization is performed based on successful completion of the additional verification by the user.

3. The method of claim 1, wherein the quality of service includes requiring additional verification from a merchant associated with the transaction, and wherein the de-tokenization is performed based on successful completion of the additional verification by the merchant.

4. The method of claim 1, wherein the quality of service comprises performing expedited processing of the de-tokenization for the transaction without any additional verification.

5. The method of claim 1, wherein the token assurance level is determined based on an identity and type of the merchant.

6. The method of claim 1, wherein the token assurance level is determined based on a dollar amount associated with the transaction, such that, for a transaction having an associated dollar amount that is less than a threshold, no additional verification is required.

7. The method of claim 1, wherein the token assurance level is determined based on a type of a mobile device associated with the transaction.

8. The method of claim 1, wherein the token assurance level is determined based on a type of payment software used for the transaction.

9. A computer program product for implementing for token assurance level based transaction processing, the computer program product comprising:
a computer readable storage medium having program instructions embodied therewith, the program instructions readable by a processing circuit to cause the processing circuit to perform a method comprising:
receiving, from a requester by a tokenization server in an electronic payment system, a request for de-tokenization of a token corresponding to a transaction;
determining a token assurance level of the token;
based on the token assurance level of the token; assigning a quality of service to the transaction; and
performing the de-tokenization based on the assigned quality of service and returning an account number corresponding to the token to the requester.

10. The computer program product of claim 9, wherein the quality of service includes requiring additional verification from a user associated with the account number, and wherein the de-tokenization is performed based on successful completion of the additional verification by the user.

11. The computer program product of claim 9, wherein the quality of service includes requiring additional verification from a merchant associated with the transaction, and wherein the de-tokenization is performed based on successful completion of the additional verification by the merchant.

12. The computer program product of claim 9, wherein the quality of service comprises performing expedited processing of the de-tokenization for the transaction without any additional verification.

13. The computer program product of claim 9, wherein the token assurance level is determined based on an identity and type of the merchant.

14. The computer program product of claim 9, wherein the token assurance level is determined based on a dollar amount associated with the transaction, such that, for a transaction having an associated dollar amount that is less than a threshold, no additional verification is required.

15. The computer program product of claim 9, wherein the token assurance level is determined based on a type of a mobile device associated with the transaction.

16. A computer system for token assurance level based transaction processing, the system comprising:
a memory; and
a processor, communicatively coupled to said memory, the computer system configured to perform a method comprising:
receiving, from a requester by a tokenization server in an electronic payment system, a request for de-tokenization of a token corresponding to a transaction;
determining a token assurance level of the token;
based on the token assurance level of the token; assigning a quality of service to the transaction; and
performing the de-tokenization based on the assigned quality of service and returning an account number corresponding to the token to the requester.

17. The system of claim 16, wherein the quality of service includes requiring additional verification from a user associated with the account number, and wherein the de-tokenization is performed based on successful completion of the additional verification by the user.

18. The system of claim 16, wherein the quality of service includes requiring additional verification from a merchant associated with the transaction, and wherein the de-tokenization is performed based on successful completion of the additional verification by the merchant.

19. The system of claim 16, wherein the quality of service comprises performing expedited processing of the de-tokenization for the transaction without any additional verification.

20. The system of claim 16, wherein the token assurance level is determined based on an identity and type of the merchant.
